(19) United States
(12) Patent Application Publication
(10) Pub. No.: US 2004/0126751 A1
(43) Pub. Date: Jul. 1, 2004

(54) Method of prolonging the life-span of living cells using NADH, NADPH and ADP-ribose

(76) Inventors: Jorg G.D. Birkmayer, Vienna (AT); Karl Nadlinger, Ternitz (AT); Seth Hallstrom, Vienna (AT); Wilhelm Westerthaler, Vienna (AT)

Correspondence Address: KENYON & KENYON, ONE BROADWAY, NEW YORK, NY, 10004, US

(21) Appl. No.: 10/330,973

(22) Filed: Dec. 27, 2002

(51) Int. Cl. A01N 1/02

(52) U.S. Cl. 435/2

(57) ABSTRACT

A method for increasing and/or enhancing the production of intracellular energy in living cells. By incubating living cells with an intracellular-energy-increasing substance, such as NADH, NADPH and/or ADP-ribose, the living cells increase their levels of intracellular energy thereby resulting in more vital, longer-living cells. Specifically, the life span and vitality of blood cells, transplantable organs and tissues, and living organisms can thereby be prolonged.

### FIELD OF THE INVENTION

The invention relates to a method of increasing and/or enhancing the production of intracellular energy in living cells. More particularly, the invention relates to the in vitro and in vivo incubating of living cells with an intracellular-energy-increasing substance, such as NADH, NADPH and/or ADP-ribose, to produce more vital, longer-living cells.

### BACKGROUND OF THE INVENTION

According to the tenets of cellular biology, living cells need energy in order to survive. Generally speaking, the more energy a living cell possesses the longer it can stay alive and vital. Thus, methods of increasing and/or maintaining the intracellular energy levels of cells will lead to more vital, longer-living cells.

Naturally, methods of producing more vital, longer-living cells would find applicability in a wide variety of technologies. For instance, blood transfusions require that vital blood cells be stored and maintained for some period of time prior to any transfusion. Red blood cells (erythrocytes) can typically be stored for transfusion for only up to about 42 days. After this time period, the red blood cells have to be discarded because they are no longer vital. That is, they have lost the ability to perform their vital functions, particularly their ability to transport oxygen.

Similarly to blood being stored for transfusions, transplantable organs and tissues are regularly stored and transported prior to any implantation thereof. Furthermore, the ability to preserve the organ and to maintain its vitality for as long as possible plays an important role in the overall success of the subsequent transplantation. In fact, there are several solutions known in the art which are disclosed as being useful in organ preservation. See, e.g., U.S. Pat. Nos. 6,365,338, 5,552,267, 5,432,053, and 5,370,989.

Therefore, it would be desirable if a method existed for increasing and/or maintaining the intracellular energy levels of cells which would result in more vital, longer-living cells. These more vital, longer-living cells could be utilized in several different applications, such as, for example, the preserving of blood for transfusions and the preserving of organs for transplantations.

Nicotinamide-adenine-dinucleotide in its reduced form (“NADH”) and nicotinamide-adenine-phosphate-dinucleotide in its reduced form (“NADPH”) are physiological substances which occur in all living cells including human cells. These substances are cofactors for a variety of enzymes, the majority of which catalyze oxidation-reduction reactions. Prior to recent discoveries as to certain therapeutic properties of these compounds, their principal utility has been as diagnostic tools in clinical biochemistry and as essential components in reaction kits, for example, in measuring lactatdehydrogenase (LDH).

The most important function of NADH is its driving force for cell respiration. When using oxygen, NADH forms water and 3 ATP molecules in accordance with the following formula:

NADH+H⁺+½O₂+3 Pi+3 ATP→NAD⁺+3 ATP+4H₂O.

Thus, with 1 NADH molecule, 3 ATP molecules are obtained which have an energy of approximately 21 kilocalories. This process is called oxidative phosphorylation. The supply of NADH and/or NADPH makes this work much easier for the organism, because it has greater energy reserves as a result. In addition, the sum of NADH and NAD⁺ is thought to be rather constant in a cell, and thus the NADH/NAD⁺ ratio is a crucial factor for determining the energetic state of the cell.

However, it has been a generally accepted tenet of biochemistry that NADH and/or NADPH do not penetrate the cell membrane, and therefore do not increase the intracellular production of adenosine triphosphate (ATP), the chemical stored form of energy. Hence, NADH and/or NADPH have never been considered as an extracellularly applicable energy donor.

More recently, NADH and NADPH and pharmaceutically acceptable salts thereof have been shown to be useful in the treatment of Parkinson's Disease. The effectiveness of these agents for this purpose is documented in my existing U.S. Pat. Nos. 4,970,200 and 5,019,561. Furthermore, in K. Vrecko et al., NADH stimulates endogenous dopamine biosynthesis by enhancing the recycling of tetrahydrobiopterin in rat phaeochromocytoma cells, Biochimica et Biophysica Acta 1361 (1997), pp. 59-65, Vrecko and coworkers have shown that NADH-supplementation of PC 12 cells leads to increased dopamine production, which is of interest for the treatment of Parkinson's Disease which is characterized by a dopamine deficit. In addition, NADH-induced increase of dopamine release could also be shown in rat striatal slices (see S. M. Pearl et al., Effects of NADH on dopamine release in rat striatum, Synapse 36(2) (2000), pp. 95-101).

In addition, I have discovered that NADH, NADPH and pharmaceutically acceptable salts thereof are effective in the treatment of Morbus Alzheimer (i.e., Alzheimer's Disease), which is the subject of my U.S. Pat. No. 5,444,053, and in the treatment of Chronic Fatigue Syndrome (CFS), which is the subject of my U.S. Pat. No. 5,712,259.

Prior to my recent discoveries, NADH and NADPH have never been considered for therapeutic use, probably because it was believed that these compounds are rather unstable and, hence, not capable of being absorbed by the intestines of the human body. It would have been expected that these substances would be hydrolyzed in the plasma within a few seconds.

However, studies performed recently using NADH and NADPH demonstrate that these assumptions are incorrect. When NADH and NADPH were applied intravenously to patients with Parkinson's disease, a remarkable beneficial effect was observed which lasted at least 24 hours. See U.S. Pat. Nos. 4,970,200 and 5,019,561. This indicates that NADH and NADPH are not rapidly degraded in the plasma and blood.

NADH and NADPH may be administered to a patient in a variety of other ways besides intravenous administration. For example, my U.S. Pat. No. 5,332,727 teaches a stable, ingestable and absorbable NADH and/or NADPH therapeutic composition which can be taken orally. It was discovered that this oral form is absorbed by the intestine, and is effective in the treatment of Parkinson's disease and Alzheimer's disease. Furthermore, my U.S. Pat. No. 5,952,312 teaches the administration of NADH and/or NADPH nasally, sublingually, rectally and topically to the skin for a variety of therapeutic effects, including prolonging the life of skin cells and reducing wrinkle formation thereof.

Besides NADH and NADPH, adenosine diphosphate ribose (ADP-ribose) is another compound occurring in living cells which is involved in cellular processes dealing with the transfer of energy. ADP-ribose contains adenine, ribose, and two phosphate groups, and it is used to produce ATP in an endergonic reaction, although it has never been considered therapeutically. ADP-ribose is formed in the cell from nicotinamide adenine dinucleotide, which is hydrolyzed to yield ADP-ribose and nicotinamide. ADP-ribose is used as a substrate for the formation of poly-ADP-ribose (see Pekala Ph., Moss J. “Poly ADP-ribosylation of protein,” Curr. Top. Cell. Regul. 1983, 22:1-49; Zahradka P., Yau L. “ADP-ribosylation and gene expression,” Moll. Cell. Biochem. 1994, Sep, 138(1-2):91-98). Poly-ADP-ribose plays a decisive role in the modification of proteins, DNA repair, differentiation and stimulation of DNA synthesis.

### SUMMARY OF THE INVENTION

It is an object of the present invention to provide a method of increasing and/or enhancing the production of intracellular energy in living cells. By incubating living cells with an intracellular-energy-increasing substance, such as for example, NADH, NADPH and/or ADP-ribose, these cells increase their levels of intracellular energy thereby resulting in more vital, longer-living cells. In describing the invention herein, only NADH and/or NADPH shall be referred to as shorthand, however, it should be appreciated that either NADH, a physiologically tolerable salt of NADH, NADPH, a physiologically tolerable salt of NADPH, or any combination thereof, can be used for all applications described herein.

It is a further object of the present invention to provide a method and solution for prolonging the life span of blood cells. By adding an intracellular-energy-increasing substance, such as NADH, NADPH and/or ADP-ribose, to a blood sample, the blood cells contained therein increase their levels of intracellular energy thereby resulting in more vital, longer-living blood cells, which may then be used, for example, in blood transfusions.

It is yet a further object of the present invention to provide a method and solution for prolonging the life span of organ cells of transplantable organs and/or tissue cells of transplantable tissues. By contacting an intracellular-energy-increasing substance, such as NADH, NADPH and/or ADP-ribose, on a transplantable organ or tissue, the organ and/or tissue cells contained therein increase their levels of intracellular energy thereby resulting in more vital, longer-living cells, and more vital, longer-living organs and/or tissues.

It is still a further object of the present invention to provide a method and composition for prolonging the life span of a living organism by administering to the living organism an effective amount of an intracellular-energy-increasing substance, such as NADH, NADPH and/or ADP-ribose. The cells of the living organism will thus increase their levels of intracellular energy, thereby resulting in more vital, longer-living cells throughout the living organism.

### BRIEF DESCRIPTION OF THE DRAWINGS

The invention will now be described in greater detail with reference to the following drawings which relate to the examples of the invention, and which are described in detail later in the specification.

FIG. 1A shows the time course of I_{K(ATP)} activation by pinacidil (30 μM) and subsequent blockade by glibenclamide (1 μM) in a representative myocyte. Sharp vertical deviations display the voltage ramp-elicited current traces.

FIG. 1B shows the original current traces, elicited by a voltage ramp, recorded at different stages of the experimental protocol as indicated by letters in FIG. 1A. The inset shows the glibenclamide-sensitive current (i.e., I_{K(ATP)}) evaluated by digital subtraction.

FIG. 2 shows the increase of outward current density at +30 mV by 30 μM pinacidil in response to different concentrations of ATPᵢ (i.e., 1 and 4.3 mM). Numbers displayed therein represent n*P<0.05.

FIG. 3 shows the concentration dependent effects of NADH incubation on I_{K(ATP)} activation by 30 μM pinacidil. Numbers displayed therein represent n*P<0.05 compared to control myocytes.

FIG. 4 shows the I_{K(ATP)} activation by 30 μM pinacidil in myocytes incubated with 400 μg/ml NADH and equimolar amounts of nicotinamide and NAD⁺. Numbers displayed therein represent n*P<0.05 compared to all groups under 30 μM pinacidil.

FIG. 5 shows the adenine nucleotide content of cardiomyocytes incubated with 400 μg/mL NADH for 4 hours versus control. The values were calculated as 100% living cells Mean±standard deviation, n=7 in each group. *P<0.000005.

### DETAILED DESCRIPTION OF THE INVENTION

In accordance with the present invention, the production of intracellular energy in living cells is increased by incubating these cells with an intracellular-energy-increasing substance, such as NADH, NADPH and/or ADP-ribose. That is, the NADH, NADPH and/or ADP-ribose is outside of the living cell and increases the production of energy, in the form of ATP, inside the living cell. In addition to ATP, the production of other energy phosphates, such as creatine phosphate, may be intracellularly increased in accordance with the method of the present invention. This resulting increase in production of energy within these living cells produces higher energy levels within the cells, which thereby result in more vital, longer-living cells.

The intracellular-energy-increasing substance of the present invention includes those substances which are taken up by a cell and thereby increase the production of intracellular energy. Preferably, the intracellular-energy-increasing substance is NADH, NADPH, ADP-ribose, or some combination thereof. Without wishing to be bound by any particular theory, it is believed that it is the hydrogen in NADH and NADPH which causes the increase in intracellular energy production. Thus, the intracellular-energy-increasing substance of the invention can include hydrogen in biologically available form. To the extent that hydrogen can be absorbed to substances other than NADH and NADPH by which it becomes bioavailable and is absorbed by the cell, such other substances can comprise the intracellular-energy-increasing substance of the invention. In addition, a combination of NADH and chlorophyll is a suitable intracellular-energy-increasing substance of the invention as chlorophyll has a higher redox potential than NADH and thus keeps NADH reduced.

The method of the present invention may be employed in both an in vitro and an in vivo environment. That is, the production of intracellular energy in living cells can be increased by incubating these cells with an intracellular-energy-increasing substance, such as NADH, NADPH and/or ADP-ribose, while these cells are either outside of a living organism or within a living organism.

In an in vitro embodiment of the method of the present invention, the life span and vitality of blood cells is prolonged by adding an intracellular-energy-increasing substance, such as NADH, NADPH, ADP-ribose, and/or a biologically available form of hydrogen, to a blood sample containing the blood cells. The blood cells increase their levels of intracellular energy resulting in more vital, longer-living blood cells. The method of the present invention can be applied to all types of blood cells, including erythrocytes, leukocytes, and/or blood platelets.

The preferred amount of intracellular-energy-increasing substance to be added to the blood sample depends upon the particular substance used. When using NADH as the intracellular-energy-increasing substance, the amount of NADH to be added to the blood sample is preferably about 10 to about 1,600 mcg/ml blood. Furthermore, when using NADH as the intracellular-energy-increasing substance to treat erythrocytes, the amount of NADH to be added to the blood sample is preferably about 10 to about 800 mcg/5×10⁹ erythrocytes (2.5 to 400 mg/250 ml blood). When NADPH is used as the intracellular-energy-increasing substance, the amount of NADPH to be added to the blood sample is preferably about ⅕ to ¼ (20-25%) of the amount of NADH that would be used. In addition, when employing ADP-ribose, the amount of ADP-ribose to be added to the blood sample is preferably about 10 to about 1,600 mcg/ml blood. When adding the intracellular-energy-increasing substance to the blood sample, the addition thereof can be done at the time that the sample was prepared, and/or at any later stage during storage thereof so long as the blood is still vital.

By prolonging the life span of blood cells, the method of the present invention allows for a longer shelf life for blood to be used in blood transfusions. That is, blood to be used in blood transfusions will be able to be stored for a longer period of time without loss of its vitality and/or functionality, thereby resulting in logistical and economical benefits. The blood supply for transfusions will increase as conserved blood samples can be stored for a longer period of time, meaning that conserved blood samples will have to be discarded less often.

In another in vitro embodiment of the method of the present invention, the life span and vitality of a transplantable organ or tissue is prolonged by contacting an intracellular-energy-increasing substance, such as NADH, NADPH and/or ADP-ribose, on the transplantable organ or tissue. The cells of the transplantable organ or tissue increase their levels of intracellular energy resulting in more vital, longer-living cells. The method of the present invention can be applied to any transplantable organ or tissue, including but not limited to a kidney, a heart, a lung and a pancreas.

In accordance with the method of the present invention, the transplantable organ or tissue is preferably perfused with a solution containing an intracellular-energy-increasing substance, such as NADH, NADPH and/or ADP-ribose, before implantation. For example, when the intracellular-energy-increasing substance is NADH, NADPH and/or ADP-ribose, the amount of these substances preferably used in the perfusing solution is similar to that previously described in relation to treating blood cells. That is, the amount of NADH present in the perfusing solution is preferably 10 mg to 400 mg NADH/250 ml perfusing solution, the amount of NADPH present in the perfusing solution is preferably about ⅕ to ¼ (20-25%) of the amount of NADH that would be used, and the amount of ADP-ribose present in the perfusing solution is preferably about 10 to about 1,600 mcg/ml perfusing solution. This process allows the perfusing solution, which contains the intracellular-energy-increasing substance, to contact the maximum number of cells of the transplantable organ or tissue, as the solution is forced throughout the entire transplantable organ or tissue.

This prolonged life span and vitality for organ or tissue cells results in a longer period of time for which a transplantable organ or tissue will retain its functionality and/or vitality. Thus, the method of the present invention serves to enhance the preservation of transplantable organs and tissues, allowing for a longer period of time during which the organ or tissue may be successfully transplanted.

In an in vivo embodiment of the method of the present invention, the life span and vitality of a living organism is prolonged by administration of an effective amount of an intracellular-energy-increasing substance, such as NADH, NADPH and/or ADP-ribose, to the living organism. In this embodiment, the cells of the living organism increase their levels of intracellular energy resulting in more vital, longer-living cells throughout the living organism. As a result, the living organism as a whole has a higher energy level, and will thus remain alive and vital for a longer period of time. Any living organism, including a human being or an animal, could be treated in accordance with this embodiment of the present invention.

Furthermore, administration of an effective amount of an intracellular-energy-increasing substance, such as NADH, NADPH and/or ADP-ribose, to a living organism has a protective effect against toxic substances. For example, if the cells of a living organism become damaged by cytostatic drugs, such as for example doxorubicin, cisplatin and the like, incubating these cells with an intracellular-energy-increasing substance, such as NADH, leads to full restoration of cellular capabilities including energy production. As the cells of living organisms are damaged via exposure to all kinds of toxins, including cigarette smoke, environmental pollutants, and “medical pollutants” (those prescription drugs, of which there are many, which cause cell damage), an intracellular-energy-increasing substance, such as NADH, NADPH and/or ADP-ribose, can function as a cell protector by repairing this cell damage. Thus, in the presence of an intracellular-energy-increasing substance, such as NADH, NADPH and/or ADP-ribose, the cells of a living organism will live longer. That is, the administration of an intracellular-energy-increasing substance, such as NADH, NADPH and/or ADP-ribose, will have a life-extending effect upon a living organism.

In accordance with an in vivo embodiment of the method of the present invention, an effective amount of an intracellular-energy-increasing substance, such as NADH, NADPH and/or ADP-ribose, is administered to a living organism in order to prolong the life span and vitality of the living organism. For example, when administering NADH to a human being, preferred daily doses between about 5 and 200 mg of NADH may be used as an effective amount; when administering NADPH to a human being, preferred daily doses between about 1 and 50 mg of NADPH may be used as an effective amount; and when administering ADP-ribose to a human being, preferred daily doses of at least between about 5 and 500 mg of ADP-ribose may be used as an effective amount.

In addition, when administering NADH to a human being in accordance with the method of the present invention, the ability of NADH to prolong the life span and vitality of the human being can be enhanced by combining the NADH with coenzyme Q10. Coenzyme Q10 is an antioxidant compound which is involved in the process of cell respiration and intracellular ATP production via oxidative phosphorylation. However, all of the commercially available coenzyme Q10 products contain the oxidized form of coenzyme Q10, meaning that in order to become active within the cell, the oxidized form of coenzyme Q10 has to be reduced in the cell, and this is exclusively accomplished by NADH. Therefore, by combining NADH with coenzyme Q10 and administering this combination to a living organism, the ability to prolong the life span and vitality of the living organism is enhanced by this synergistic combination as compared to that of NADH alone.

When NADH or NADPH are administered to a living organism in accordance with this embodiment, they can be manufactured in the usual way with pharmaceutically acceptable fillers, or they can be incorporated for use into conventional galenic formulations for oral, parenteral, rectal, dermal, sublingual and nasal applications. The preparations can exist: in a solid form as tablets, capsules or coated tablets; in liquid form as a solution, suspension, spray or emulsions; in the form of suppositories, as well as in formulations having a delayed release of the active substances. Suitable nasal, sublingual, rectal and dermal delivery methods and formulations for NADH and NADPH can be found in my U.S. Pat. No. 5,750,512, which is hereby incorporated by reference.

Specific preferred embodiments of the invention will now be described with reference to the following examples which should be regarded in an illustrative rather than a restrictive sense.

### EXAMPLES

The effect of extracellular application of NADH on the energetic state of a cell was examined by studying NADH-incubated cardiac ventricular myocytes with electrophysiological and biochemical analytical techniques.

The electrophysiological properties of a cardiac myocyte are strongly affected by its energetic condition. Particularly, the adenosine triphosphate (ATP)-dependent potassium current (I_{K(ATP)}) is known to link bioenergetic metabolism with membrane excitability by sensing intracellular concentrations of ATP and adenosine diphosphate (ADP). Under physiological conditions, ATP-dependent potassium channels (K_{(ATP)}-channels) are predominantly closed due to inhibition by intracellular ATP (ATPᵢ). However, when the ATPᵢ concentration falls below certain values (like in pathological states such as acute myocardial ischaemia), the K_{(ATP)}-channels open. Certain drugs known as potassium channel openers (PCOs) are able to shift the ATP-sensitivity of K_{(ATP)}-channels resulting in channels opening even at physiological levels of ATPᵢ. Thus, the amount of I_{K(ATP)} activation induced by these drugs serves as an indicator of the intracellular ATP-content.

In this example, guinea pig ventricular myocytes were isolated by Langendorff perfusion using collagenase, as is described in H. M. Piper et al., Culturing of calcium stable adult cardiac myocytes, J. Mol. Cell Cardiol. 14 (1982), pp. 397-412. The isolated myocytes were stored in a cell culture medium M 199 (Sigma™, St. Louis, Mo.), supplemented with 5 μg/ml penicillin and 5 IU/ml of streptomycin and were kept in an incubator at 37° C. All experiments were performed within 24 hours after isolation of the myocytes.

The isolated myocytes were then incubated with NADH (β-nicotinamide adenine dinucleotide, reduced form, disodium salt, Roche™, Mannheim, Germany) and the related compounds nicotinamide and NAD⁺ (β-nicotinamide adenine dinucleotide, oxidized form, Sigma™) in eqimolar amounts 4 to 6 hours before electrophysiological parameters were evaluated.

Membrane currents were recorded using the whole-cell single electrode voltage-clamp configuration of the patch-clamp technique (see O. P. Hamill et al., Improved patch-clamp techniques for high-resolution current recording from cells and cell-free membrane patches, Pflüger's Arch. 391 (1981), pp. 85-100) using a List L/M-EPC 7 amplifier (List™, Darmstadt, Germany) as previously described by Pelzmann and coworkers in B. Pelzmann et al., Effects of K⁺ channel openers on I_{K(ATP)} of human atrial myocytes at physiological temperatures, Naunyn-Schmiedeberg's Arch. Pharmacol. 363 (2001), pp. 125-132. Myocytes were placed in an experimental chamber mounted on the stage of an inverted microscope (Zeiss Axiovert™, Oberkochen, Germany) and superfused with standard extracellular solution (composition in mM: NaCl 137, KCl 5.4, CaCl₂ 1.8, MgCl₂ 1.1, NaHCO₃2.2, NaH₂PO₄ 0.4, HEPES/Na⁺ 10, D(+)-glucose 5.6, adjusted to a pH of 7.4 with NaOH) at 36-37° C. with a flow rate of about 1.5 ml/min. When filled with standard internal solution (composition in mM: KCl 110, ATP/K⁺ 4.3, MgCl₂ 2, CaCl₂ 1, EGTA 11, HEPES/K⁺ 10, adjusted to a pH of 7.4 with KOH) and placed into standard external solution, patch-pipette tip resistances were 1 to 3 MΩ. Only quiescent rod-shaped cells with clear cross striation were used for voltage-clamp experiments. Cell membrane capacitance (Cₘ) was determined by integration of the capacitive transient elicited by a 10 mV hyperpolarizing pulse from −50 mV. Cₘ (up to 100 pF) and series resistance (Rₛ, by at least 50%) were compensated. Voltage-clamp pulses were generated with an IBM-compatible computer connected to a D/A and A/D converter (Digidata 1200™, Axon Instruments, Foster City, USA). Data acquisition and analyses were performed using pCLAMP 5.7.1 software (Axon Instruments). In order to allow equilibration of the pipette solution with the cytosol, current recordings were started five minutes after rupture of the membrane patch.

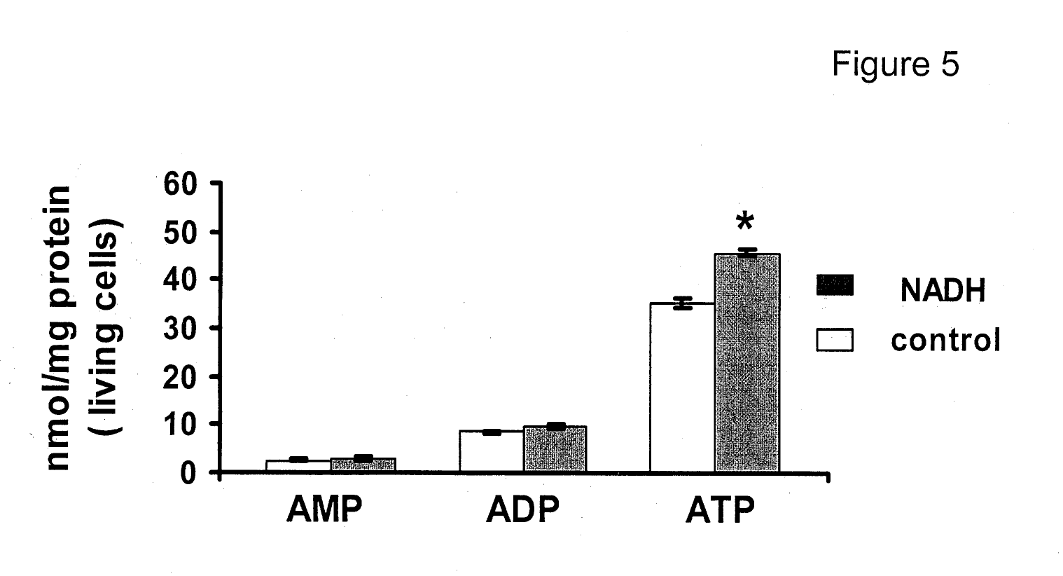

Two experimental protocols were used in these examples. Modulation of I_{K(ATP)} by drugs was evaluated as the change of outward current density (current amplitudes divided by Cₘ (pA/pF) in order to compensate for variations in cell size) at +30 mV in response to a 2 second ramp from −100 to +60 mV (Iᵣₐₘₚ). Time course of I_{K(ATP)} activation and blockade was studied by recording the holding current at −40 mV (I_{hold(-40 mV)}). Stock solutions of I_{K(ATP)} channel blocker glibenclamide (Sigma™) and of K_{(ATP)} channel opener pinacidil (Sigma™) were prepared in dimethyl sulfoxide (DMSO). Averaged data are expressed as a mean±standard deviation (or standard error of the mean, SEM), with n=number of cells. Error bars in the figures represent standard deviations (except in FIG. 5).

The analytical method used for the determination of adenine nucleotides was that reported in Hallström, S. et al., “S-nitroso human serum albumin treatment reduces ischemia/reperfusion injury in skeletal muscle via nitric oxide release,” Circulation, 105 (2002), 3023-3038 (“Hallström et al.”). In brief, the only alterations from the analytical method reported by Hallström et al. were as follows: separation was performed on a Hypersil ODS column (5 μm, 250 mm×4 mm I.D.) using a Waters™ 717 plus Autosampler, two constaMetric™ III pumps, a gradient controller (LDC/Milton Roy) and a Waters™ 969 photodiode array detector; detector signals (absorbance at 254 nm) were recorded with an AGC™ Personal Computer; and the program Millennium (Waters™) was used for data requisition and analysis. Cardiomyocytes were deproteinized with 250 μL of 0.4 M/L perchloric acid. After centrifugation (12,000 g), 200 μL of the acid extract were neutralized with 12.5 μL of 2 M potassium carbonate (4° C.). The supernatant (10 μL) obtained after centrifugation was used for High Performance Liquid Chromatography (HPLC) analysis. The pellets of the acid extract were dissolved in 1 mL of 0.1 M sodium hydroxide and further diluted 1:10 with physiologic saline for protein determination (BCA Protein Assay, Pierce). The percentage of living cells was estimated by determining the ratio of the number of rod shaped to rounded myocytes. At least 600 myocytes were counted for each preparation.

Statistical significance was determined by a two-tailed Student's t-test or, if more than two conditions were compared, by one-way analysis of variance (ANOVA) with the LSD (least significant difference) post hoc test. Differences were considered significant when P<0.05.

### Activation of I_{K(ATP)} by Pinacidil

Mean membrane capacitance (Cₘ) of isolated guinea pig ventricular myocytes used in this example was 113.6±3.13 pF (n=102). Under physiological conditions (4.3 mM ATP in the pipette solution, ATPᵢ), outward current density of Iᵣₐₘₚ was 2.19 ±0.26 pA/pF at +30 mV (n=19). I_{K(ATP)} did not contribute to the basal electrical activity since glibenclamide, a K_{(ATP)} channel blocker did not affect Iᵣₐₘₚ (data not shown). Under physiological conditions, K_{(ATP)} channels are predominantly in the closed state caused by a strong inhibition of channel activity at an ATPᵢ concentration in the millimolar level as shown in A. Noma, ATP-regulated K⁺ channels in cardiac muscle, Nature 305 (1983), pp. 147-148. Similar observations were made in human atrial myocytes. See H. Heidbüchel et al., Three different potassium channels in human atrium, Circ. Res. 66 (1990), pp. 1277-1286; S. I. Koumi et al., Alterations in ATP-sensitive potassium channel sensitivity to ATP in failing human heart, Am. J. Physiol. 272 (1997), pp. H1656-H1665.

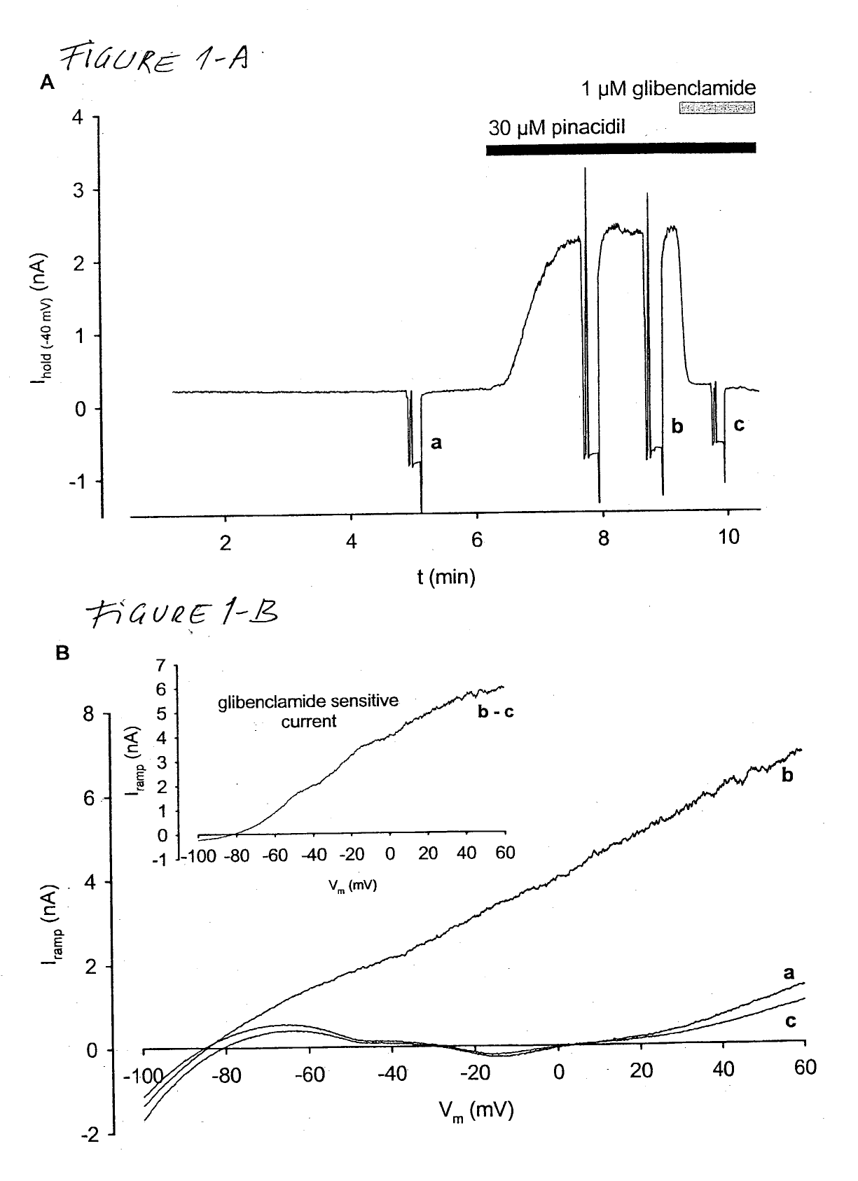

In several studies the K_{(ATP)} channel opener pinacidil was shown to activate I_{K(ATP)} in ventricular cardiomyocytes (see, e.g., J. P. Arena et al., Enhancement of potassium-sensitive current in heart cells by pinacidil, Circ. Res. 65 (1989), pp. 436-445; J. K. Smallwood et al., Cardiac electrophysiological effects of pinacidil and related pyridylcyanoguanidines: relationship to anti hypertensive activity, J. Cardiovasc. Pharmacol. 12 (1988), pp. 102-109) by increasing the open probability of the K_{(ATP)} channel (see S. Isomoto et al., Function, regulation, pharmacology and molecular structure of ATP-sensitive K⁺ channels in the cardiovascular system, J. Cardiovasc. Electrophysiol. 8 (1997), pp. 1431-1446). In the present example, pinacidil activated a current which was completely inhibited by the sulfonylurea glibenclamide. FIG. 1A shows the effect of pinacidil on I_{hold(-40 mV)} and Iᵣₐₘₚ of a representative myocyte. Exposure to 30 μM pinacidil caused I_{K(ATP)} activation, shown as a strong increase in I_{hold(-40 mV)}. Superfusion of the cell with the sulfonylurea glibenclamide (1 μM) completely inhibited I_{K(ATP)} almost immediately, and the holding current returned to control level (FIG. 1A). FIG. 1B shows the original current traces elicited by a voltage ramp applied at different stages of the experimental protocol as indicated by letters in FIG. 1A. The current-voltage relationship recorded under control conditions showed the typical shape for ventricular myocytes. During application of pinacidil a large increase in membrane current could be observed. Addition of 1 μM glibenclamide completely reversed this effect, as the current returned to almost control values. The glibenclamide-sensitive current (inset of FIG. 1B) obtained by digital subtraction represents I_{K(ATP)} with similar characteristics as described in other studies (see J. P. Arena et al., Enhancement of potassium-sensitive current in heart cells by pinacidil, Circ. Res. 65 (1989), pp. 436-445; S. I. Koumi et al., Alterations in ATP-sensitive potassium channel sensitivity to ATP in failing human heart, Am. J. Physiol. 272 (1997), pp. H1656-Hl665; A. Noma et al., Membrane current through adenosine-triphosphate-regulated potassium channels in guinea-pig ventricular cells, J. Physiol. (Lond) 363 (1985), pp. 463-480) showing an almost linear current-voltage relationship. A reversal potential of about −80 mV indicates a high selectivity for potassium ions. Under exposure of 30 μM pinacidil the outward current density at +30 mV was 28.9±3.38 pA/pF (n=19). After a washout period of 5 minutes, the current density returned to control values (1.81±0.22 pA/pF, n=12).

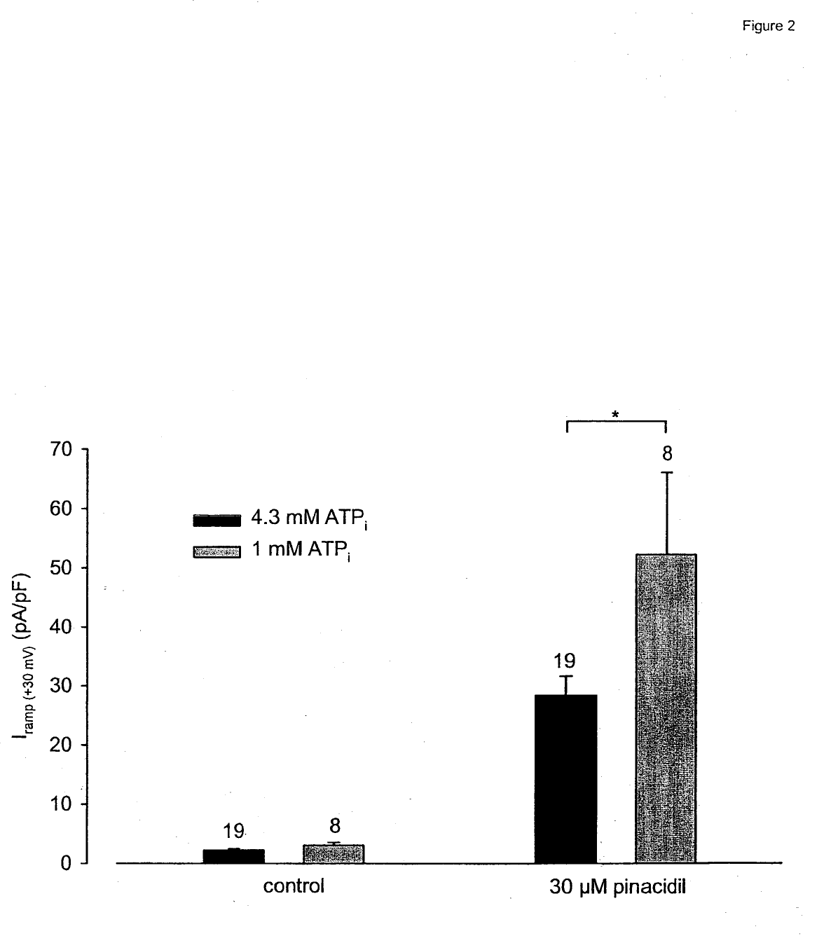

FIG. 2 shows the pinacidil (30 μM)-induced activation of I_{K(ATP)}, demonstrated as the increase in Iᵣₐₘₚ density at +30 mV in the presence of a physiological (4.3 mM) and a low (1 mM) ATPᵢ concentration. Under control conditions (measured five minutes after rupture of the membrane patch) I_{ramp (+}30 mv) density was not statistically different at physiological and low ATPᵢ (2.19±0.26 (n=19) and 3.02±0.51 (n=8) pA/pF using 4.3 and 1 mM ATPᵢ, respectively). However, using 1 mM ATPᵢ the pinacidil-induced increase in outward current density was significantly higher compared to 4.3 mM ATPᵢ (P<0.05). The current density was 28.3±3.26 (n=19) and 52.2±13.8 (n=8) pA/pF at 4.3 and 1 mM ATPᵢ, respectively. These results are in line with previous observations reporting that the action of pinacidil depends on ATPᵢ with increasing sensitivity to openers at lower ATPᵢ (see e.g., J. P. Arena et al., Enhancement of potassium-sensitive current in heart cells by pinacidil, Circ. Res. 65 (1989), pp. 436-445; K. Nakayama et al., Interrelation between pinacidil and intracellular ATP concentrations on activation of the ATP-sensitive K⁺ current in guinea pig ventricular myocytes, Circ. Res. 67 (1990), pp. 1124-1133; G. Tseng et al., Actions of pinacidil on membrane currents in canine ventricular myocytes and their modulation by intracellular ATP and CAMP, Pflüger's Arch. 415 (1990), pp. 414-424; B. Pelzmann et al., Effects of K⁺ channel openers on I_{K(ATP)} of human atrial myocytes at physiological temperatures, Naunyn-Schmiedeberg's Arch. Pharmacol. 363 (2001), pp. 125-132). Thus, the pinacidil-primed I_{K(ATP)} serves as an indicator of subsarcolemmal ATP concentration as already convincingly shown by Sasaki and coworkers (see N. Sasaki et al., ATP consumption by uncoupled mitochondria activates sarcolemmal K_{ATp} channels in cardiac myocytes, Am. J. Physiol. Heart Circ. Physiol. 280 (2001), pp. H1882-H1888).

Almost all of the cardiac ATP is regenerated by respiratory chain-linked phosphorylation whereby the energy reaching the respiratory chain is mainly supplied as the reduced coenzyme NADH which is oxidized by complex I of the respiratory chain. The cellular NADH content can be influenced by the extracellular supply of metabolic substrates. Recently, Williams and coworkers (see H. Williams et al., Glutamate-loading stimulates metabolic flux and improves cell recovery following chemical hypoxia in isolated cardiomyocytes, J. Mol. Cell. Cardiol. 33 (2001), pp. 2109-2119) showed that due to the presence of glutamate during isolation procedure the intracellular glutamate concentration in single isolated rat myocytes could be raised; this in turn increased metabolic flux as indicated by a higher NADH/NAD⁺ ratio and ATP content, as well as improved recovery from simulated hypoxia. The NADH/NAD⁺ ratio could also be increased by the addition of other metabolic substrates like pyruvate (see H. Williams et al., Glutamate-loading stimulates metabolic flux and improves cell recovery following chemical hypoxia in isolated cardiomyocytes, J. Mol. Cell. Cardiol. 33 (2001), pp. 2109-2119; R. L. White et al., Mitochondrial NAD(P)H, ADP, oxidative phosphorylation, and contraction in isolated heart cells, Am. J. Physiol. Heart Circ. Physiol. 279 (2000), pp. H1849-1857).

The activity of cardiac K_{ATP} channels is controlled by a cytosolic ATP-pool for which oxidative phosphorylation is the predominant ATP source (see A. Knopp et al., Mitochondria are the main ATP source for a cytosolic pool controlling the activity of ATP-sensitive K⁺ channels in mouse cardiac myocytes, Cardiovasc. Res. 52 (2001), pp. 236-245). Since the respiratory chain is fueled mainly with NADH, the present example investigates whether NADH-supplementation per se leads to an improved metabolic state of cardiomyocytes using the pinacidil-primed I_{K(ATP)} as a sensor of the subsarcolemmal ATP concentration.

Effects of Incubation with NADH and Related Compounds

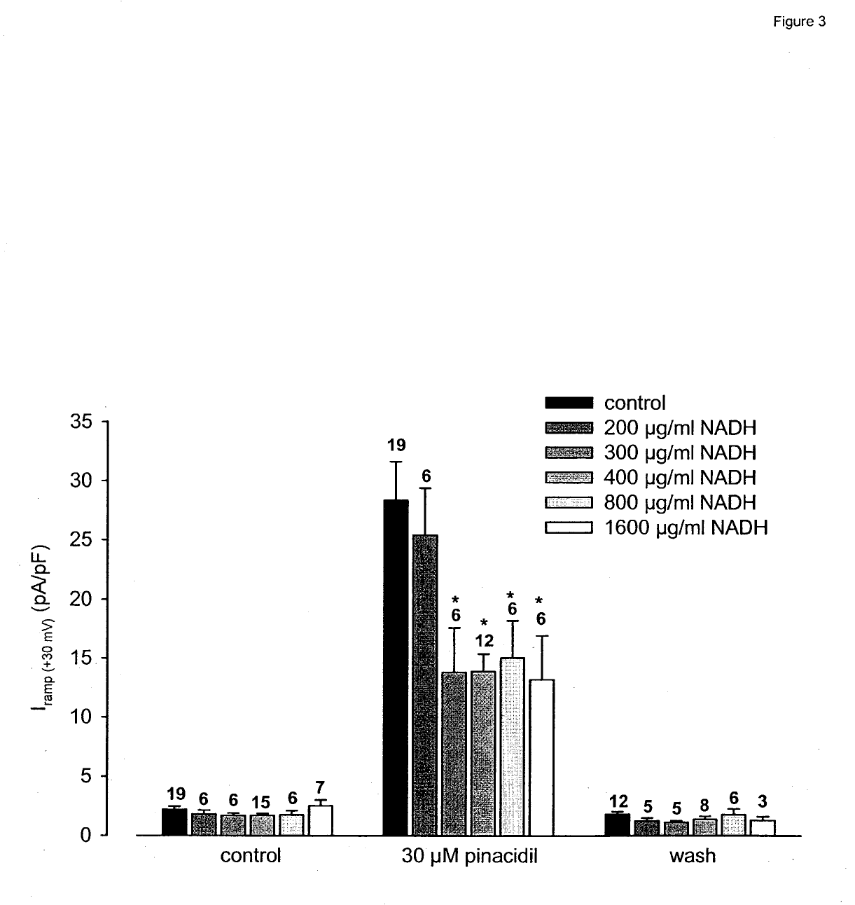

FIG. 3 shows the concentration dependent effect of NADH on I_{K(ATP)} activation by 30 μM pinacidil under physiological conditions (4.3 mM ATPᵢ). Guinea pig ventricular myocytes were incubated with different concentrations of NADH (200, 300, 400, 800, 1600 μg/ml cell-culture medium) for 4-6 hours before electrophysiological experiments were performed. Under control conditions outward current density at +30 mV was not different between control and NADH-incubated cells. The current density was 2.19±0.26 (n=19), 1.82±0.33 (n=6), 1.72±0.19 (n=6), 1.70±0.18 (n=15), 1.76±0.36 (n=6) and 2.53±0.49 (n=7) pA/pF in control and after incubation with 200, 300, 400, 800 and 1600 μg/ml NADH, respectively.

Incubation of the myocytes with 200 μg/ml NADH resulted in a reduced I_{K(ATP)} activation by pinacidil compared to control cells, but this effect did not reach statistical significance (28.3±3.26 (n=19) versus 25.4±3.97 (n=6) pA/pF at +30 mV). However, when using 300 μg/ml NADH, outward current density after application of pinacidil was significantly reduced (13.8±3.78, n=6; P<0.05). A further increase of NADH concentration did not further diminish the effect of pinacidil on I_{K(ATP)} activation. The outward current density was 13.9±1.49 (n=12), 15.0±3.19 (n=6) and 13.2±3.74 (n=6) pA/pF in myocytes incubated with 400, 800 and 1600 μg/ml NADH, respectively. The effect of the K_{(ATP)} channel opener pinacidil could be washed out completely. The outward current density returned almost to the initial value and was 1.81±0.21 (n=12), 1.24±0.24 (n=5), 1.09±0.14 (n=5), 1.37±0.25 (n=8), 1.75±0.48 (n=6) and 1.29±0.31 (n=3) in control and after incubation with 200, 300, 400, 800 and 1600 μg/ml NADH, respectively.

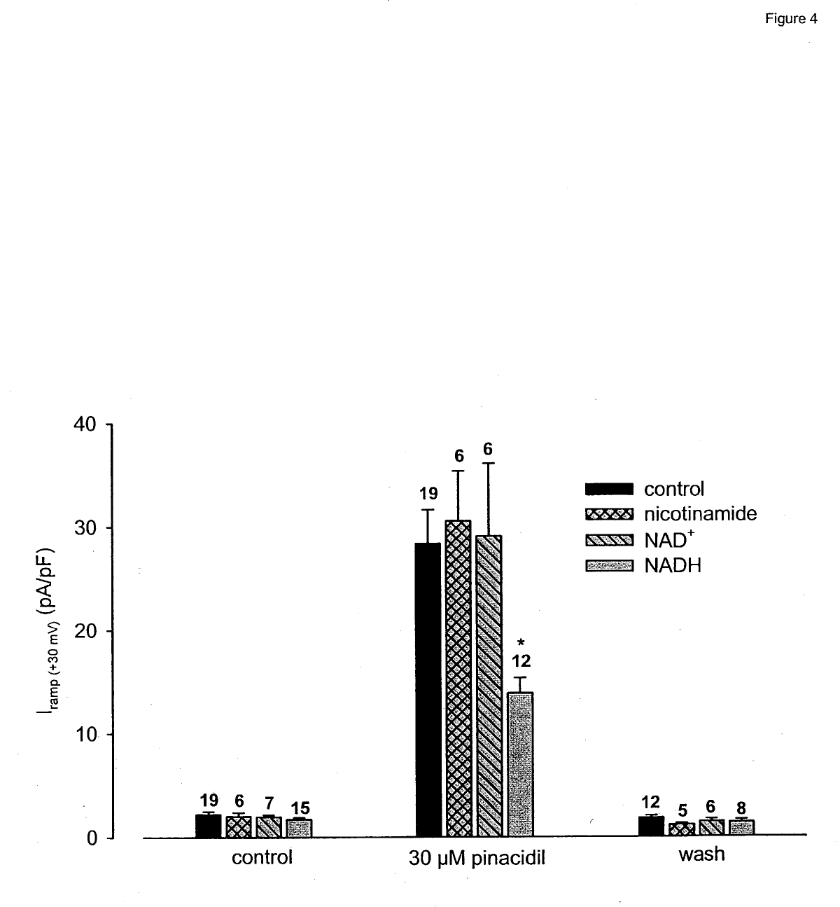

To investigate if this decreased activation of I_{K(ATP)} by pinacidil is a specific effect of the NADH or can also be caused by related compounds, the results with 400 μg/ml NADH were compared with eqimolar amounts of nicotinamide and NAD⁺ (see FIG. 4). Under control conditions there was no difference in outward current density (2.19±0.26 (n=19), 2.01±0.36 (n=6), 1.96±0.20 (n=7) and 1.70±0.18 (n=15) pA/pF in control and after incubation with nicotinamide, NAD⁺ and NADH, respectively). I_{K(ATP)} activation by pinacidil, however, could neither be reduced by nicotinamide nor by NAD⁺ to the same extent as was accomplished by NADH (P<0.05). That is, there was no statistically significant difference between currents in control myocytes and myocytes incubated with nicotinamide or NAD⁺. Outward current density at +30 mV after addition of 30 μM pinacidil was 28.3±3.26 pA/pF (n=19) in control myocytes and 30.5±4.83 (n=6) and 29.0±7.01 (n=6) pA/pF in nicotinamide and NAD⁺ incubated cells, respectively. After a washout period the outward current density returned to nearly control values. It was 1.81±0.22 (n=12), 1.13±0.15 (n=5), 1.44±0.25 (n=6) and 1.37±0.25 (n=8) in control and after incubation with nicotinamide, NAD⁺ and NADH, respectively.

To confirm that the mechanism of NADH supplementation induced the decreasing of pinacidil-primed I_{k(ATP)}, the intracellular adenine nucleotide content in cardiomyocytes was measured with and without NADH supplementation. FIG. 5 shows the summarized results thereof. The increase in ATP content in cardiomyocytes after four hours supplementation with NADH (400 mcg per ml cell culture medium) was highly significant (45.59±1.88 nmol/mg protein of living cells) versus control (35.35±2.57 nmol/mg protein of living cells)(P<0.000005, n=7); whereas ADP and AMP showed no significant alteration after incubation with NADH compared to control.

The results of this example show that incubation of guinea pig ventricular myocytes with 300 μg/ml NADH (4-6 hours) causes a significantly reduced I_{K(ATP)} activation by pinacidil compared to control cells indicating an increased subsarcolemmal ATP concentration. These results were confirmed by measuring the intracellular adenine nucleotide content revealing a highly significant increase in ATP content in cardiomyocytes supplemented with NADH, whereas ADP and AMP values did not significantly differ from control.

In summary, our example shows that NADH-supplementation, but not that of the related compounds nicotinamide and NAD⁺, improves the metabolic state of isolated ventricular myocytes indicated by a decreased pinacidil-primed I_{K(ATP)}. Measurement of adenine nucleotides confirmed a significant elevation of ATP levels in cardiomyocytes treated with NADH. Since the pinacidil-primed I_{K(ATP)} can be used as an indicator of subsarcolemmal ATP concentration (see N. Sasaki et al., ATP consumption by uncoupled mitochondria activates sarcolemmal K_{ATP} channels in cardiac myocytes, Am. J. Physiol. Heart Circ. Physiol. 280 (2001), pp. H1882-H1888), although not wishing to be bound by any particular theory we conclude that NADH-supplementation increases intracellular ATP level due to an elevated NADH/NAD⁺ ratio. That is, incubation of cardiomyocytes with NADH, but not with the related compounds nicotinamide and NAD⁺, results in a decrease of I_{K(ATP)} activation by pinacidil consistent with an increase of cellular ATP content induced by extracellular application of NADH.

As previously explained, the increased intracellular energy levels of these cells will result in these cells being more vital, longer-living cells. This method of producing more vital, longer-living cells can be used, for example, in the preserving of blood for transfusions, the preserving of organs for transplantations, and the prolonging of the life span for living organisms.

In the foregoing specification, the invention has been described with reference to specific exemplary embodiments thereof. It will, however, be evident that various modifications and changes may be made thereto without departing from the broader spirit and scope of the invention as set forth in the appended claims. The specification should therefore be regarded in an illustrative rather than a restrictive sense.

What is claimed is:

1. A method of prolonging the life span and vitality of a blood cell comprising:
adding an intracellular-energy-increasing substance to a blood sample containing the blood cell, wherein the intracellular-energy-increasing substance comprises NADH, a physiologically tolerable salt of NADH, NADPH, a physiologically tolerable salt of NADPH, ADP-ribose, or a physiologically tolerable salt of ADP-ribose.

2. The method of claim 1, wherein the blood cell comprises a member selected from the group consisting of an erythrocyte, a leukocyte and a blood platelet.

3. The method of claim 1, wherein the intracellular-energy-increasing substance comprises NADH.

4. The method of claim 3, wherein the NADH is added in an amount of from about 10 to about 1,600 mcg/ml of the blood sample.

5. The method of claim 1, wherein the intracellular-energy-increasing substance comprises ADP-ribose.

6. The method of claim 5, wherein the ADP-ribose is added in an amount of from about 10 to about 1,600 mcg/ml of the blood sample.

7. A method of prolonging the life span and vitality of a transplantable organ or a transplantable tissue, said method comprising:
contacting an intracellular-energy-increasing substance on at least one of a transplantable organ and a transplantable tissue, wherein the intracellular-energy-increasing substance comprises NADH, a physiologically tolerable salt of NADH, NADPH, a physiologically tolerable salt of NADPH, ADP-ribose, or a physiologically tolerable salt of ADP-ribose.

8. The method of claim 7, wherein the transplantable organ comprises a member selected from the group consisting of a kidney, a heart, a lung and a pancreas.

9. The method of claim 7, wherein the contacting comprises perfusing at least one of the transplantable organ and the transplantable tissue with the intracellular-energy-increasing substance.

10. The method of claim 7, wherein the intracellular-energy-increasing substance comprises NADH.

11. The method of claim 7, wherein the intracellular-energy-increasing substance comprises ADP-ribose.

12. A method of prolonging the life span and vitality of a living organism, said method comprising:
administering to the living organism an effective amount of an intracellular-energy-increasing substance, wherein the intracellular-energy-increasing substance comprises NADH, a physiologically tolerable salt of NADH, NADPH, a physiologically tolerable salt of NADPH, ADP-ribose, or a physiologically tolerable salt of ADP-ribose.

13. The method of claim 12, wherein the living organism is a human being.

14. The method of claim 13, wherein the intracellular-energy-increasing substance comprises NADH, and the effective amount comprises between about 5 and 200 mg of NADH per day.

15. The method of claim 13, wherein the intracellular-energy-increasing substance comprises NADPH, and the effective amount comprises between about 1 and 50 mg of NADPH per day.

16. The method of claim 13, wherein the intracellular-energy-increasing substance comprises ADP-ribose, and the effective amount comprises between about 5 and 500 mg of ADP-ribose per day.

17. The method of claim 12, wherein the intracellular-energy-increasing substance comprises NADH and coenzyme Q10.

18. The method of claim 12, wherein the living organism is an animal.
